(19) United States
(12) Patent Application Publication
(10) Pub. No.: US 2010/0257136 A1
(43) Pub. Date: Oct. 7, 2010

(54) Data Integration and Virtual Table Management

(76) Inventors: Steven Velozo, Seattle, WA (US); Alex Decker, Seattle, WA (US); Chintan Gandhi, Seattle, WA (US)

Correspondence Address: NEWMAN & NEWMAN, ATTORNEYS AT LAW, LLP, 505 FIFTH AVENUE SOUTH, SUITE 610, SEATTLE, WA, 98104, US

(21) Appl. No.: 12/546,496

(22) Filed: Aug. 24, 2009

Related U.S. Application Data
(60) Provisional application No. 61/166,624, filed on Apr. 3, 2009.

(51) Int. Cl. G06F 17/30

(52) U.S. Cl. 707/602; 707/E17.005; 707/E17.044

(57) ABSTRACT

Described is a system, method, and product for integrating data and transforming the data for storage in a data warehouse. One or more data files are received at a staging area and are transmitted to a transformation module. The transformation module transforms the one or more data files into standardized data which conforms to one or more standards. The standardized data is transmitted to and stored in a virtual table aggregator. After verification that the standardized data conforms to the one or more standards, the verified standardized data is stored in a data warehouse.

### CROSS-REFERENCE TO RELATED APPLICATION

This application claims the benefit of Provisional Patent Application Ser. No. 61/166,624, filed Apr. 3, 2009, for all purposes including but not limited to the right of priority and benefit of earlier filing date, and expressly incorporates by reference the entire content of Provisional Patent Application Ser. No. 61/166,624.

### BACKGROUND

In recent years, organizations have adopted data systems which do not provide the separate units within those organizations—for example, a corporation's departments, divisions, and headquarters—with an effective means of collecting accurate data, aggregating the data, and analyzing the data to make well-informed policy decisions. By way of example and without limitation, school districts often struggle to collect accurate data, using ineffective legacy systems. In order to meet reporting requirements at the state and national levels, the school districts must frequently implement multiple additional data systems which enable them to create ad hoc reports. Within a school district, it is common to find antiquated Student Information Systems (SIS) which contain a small amount of necessary information, and ten to twenty additional systems which provide separate pools of vital information. Because each vendor has a different outlook regarding the importance of different types of information, and because many of the data systems used by school districts are outdated, interoperability between different data systems is difficult or impossible to achieve. In addition, the quality of the data produced is often riddled with human error and variation, since the school districts often use manual processes to create one-off, ad hoc reports in response to state-level requests for data. The ability to use data to influence decision making is lost because of the struggles with the disparate underlying data systems and the nonstandard methodologies used in creating data reports.

Unfortunately, a data integration and transformation method that makes it possible for organizational units to share accurate and reliable data in a standardized form has eluded those skilled in the art, until now.

### SUMMARY

The present invention provides a method for integrating data and transforming the data for storage in a data warehouse, and a system and product for its implementation.

### BRIEF DESCRIPTION OF THE DRAWINGS

FIG. 1 illustrates by way of a block diagram one embodiment of the present invention in the use of a method, system, and product for data integration and virtual table management.

FIG. 2 is a functional block diagram illustrating in greater detail one implementation of the data transformer introduced in conjunction with FIG. 1.

FIG. 3 is a functional block diagram illustrating in greater detail one implementation of the data aggregator introduced in conjunction with FIG. 1.

FIG. 4 illustrates by way of a schematic flow diagram another embodiment of the present method, system, and product for data integration and virtual table management.

FIG. 5 is another schematic flow diagram illustrating in greater detail the process for transforming data files introduced at step 405 in conjunction with FIG. 4.

FIG. 6 is yet another schematic flow diagram illustrating in greater detail the process for verifying standardized data introduced at step 409 in conjunction with FIG. 4.

### DETAILED DESCRIPTION

In the following discussion, many specific details are provided to set forth a thorough understanding of the present invention. It will be obvious, however, to those skilled in the art that the present invention may be practiced without the explicit disclosure of some specific details, and in some instances of this discussion with reference to the drawings, known elements have not been illustrated in order to not obscure the present invention in unnecessary detail. Such details concerning computer networking, software programming, telecommunications and the like may at times not be specifically illustrated as such are not considered necessary to obtain a complete understanding of the core present invention, but are considered present nevertheless as such are considered to be within the skills of persons of ordinary skill in the art.

It is also noted that, unless indicated otherwise, all functions described herein may be performed in either hardware or software, or some combination thereof. In some embodiments the functions may be performed by a processor, such as a computer or an electronic data processor, in accordance with code, such as computer program code, software, and/or integrated circuits that are coded to perform such functions. Those skilled in the art will recognize that software, including computer-executable instructions, for implementing the functionalities of the present invention may be stored on a variety of computer-readable media including hard drives, compact disks, digital video disks, integrated memory storage devices and the like.

Furthermore, the following discussion is for illustrative purposes only, and discusses the present invention in reference to various embodiments which may perhaps be best utilized subject to the desires and subjective preferences of various users. One of ordinary skill in the art will, however, appreciate that the present invention may be utilized in a great variety of forms in the integration and management of data of any type. Unless explicitly stated, the method embodiments described herein are not constrained to a particular order or sequence. Additionally, some of the described method embodiments or elements thereof can occur or be performed at the same point in time.

The various embodiments described herein are directed to a method, system, and product for data integration and virtual table management. Briefly stated, the present invention allows one or more data files from multiple data sources to be amalgamated via a mapping process into a staging area. The data files can then be validated, cleansed and processed to conform to one or more standards of a data warehouse—i.e., a server or other storage device capable of storing and organizing data. After the data files are transformed into standardized data, the standardized data may be stored in a virtual table aggregator (VTA) for final user verification before actual import takes place. The data files may be flat, nonrelational files such as comma-separated values (CSV) files or tab-delimited (TAB) files. The standardized data may be in the form of a multidimensional data structure from which one or more multidimensional data sets may be created.

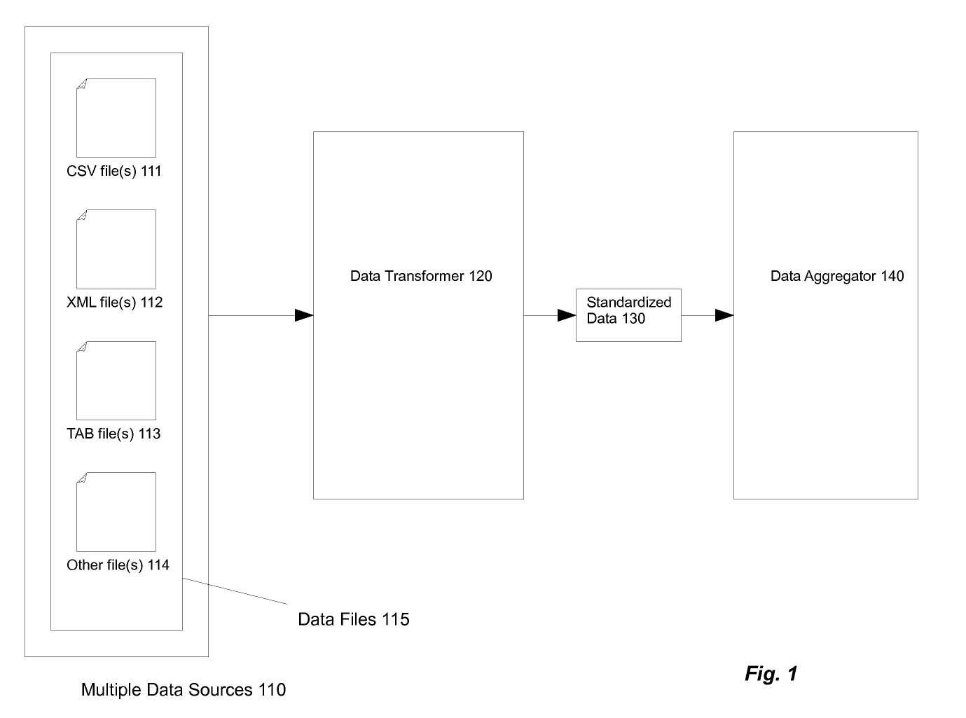

Referring now to FIG. 1, there is shown in the form of a block diagram one embodiment of an aspect of the present invention for data integration and virtual table management. Any combination of data storage devices, including without limitation computer servers, using any combination of programming languages and operating systems that support network connections, is contemplated for use in the present inventive method, system, and product. By way of example and without limitation, the Microsoft .NET framework may be used. The inventive method, system, and product are also contemplated for use with any communication network, and with any method or technology which may be used to communicate with said network, including without limitation wireless fidelity networks, Ethernet, Universal Serial Bus (USB) cables, TCP/IP wide-area networks, the Internet, and the like.

The integration and transformation of data which can be sent or received by way of a telephone device, through the Internet, or through any other electronic delivery means, is contemplated in conjunction with the present invention. A non-limiting example includes, for illustration purposes only, the integration and transformation of one or more flat, nonrelational data files into a multidimensional data structure comprising one or more data cubes and/or data tables. In short, a description of the data files contemplated to be integrated and transformed in accordance with the present invention is only limited by one's imagination, and may conceivably be anything or take any form. Further, a description of the standardized data contemplated to be produced in accordance with the present invention is only limited by one's imagination, and may conceivably be anything or take any form.

As shown in FIG. 1, one or more data files 115 are transmitted from multiple data sources 110 to data transformer 120. Data files 115 may be transmitted from multiple data sources 110 to data transformer 120 wirelessly or by any other means. Data files 115 may include any data including but not limited to XML files, JS files, CSS files, SQL (Structured Query Language) files, and PL/SQL (Procedural Language/Structured Query Language) files. In this particular embodiment, data files 115 include one or more CSV file(s) 111, one or more XML file(s) 112, one or more tab delimited (TAB) file(s) 113, and one or more other data file(s) 114.

Data files 115 may include any type of data, without limitation. For example, the data files may contain student demographic information as defined by federal, state, and district reporting guidelines. The data files may contain student and teacher rostering information. The data files may contain student assessment data which may be transformed and aggregated into standardized data, thereby permitting referential and comparative analysis of the standardized data with curriculum and grade bias measurement. The data files may contain information about student addresses, as well as students' siblings, parents, guardians, and other family members. The data files may contain information about teacher certifications, credentials, and degrees.

Multiple data sources 110 may comprise one or more servers, desktop computers, laptop computers, or other data storage devices, each of which is associated with a particular unit within an organization. For example and without limitation, each of the data sources which comprise multiple data sources 110 may be associated with one or more particular departments, divisions, or headquarters of a corporation. In another embodiment, each of the data sources which comprise multiple data sources 110 may be associated with one or more particular students, teachers, schools, classes, local school districts, state departments of education, the U.S. Department of Education, or any other types of entities or persons associated with a particular educational system, including but not limited to one or more cafeterias, social service organizations, and extracurricular organizations. Multiple data sources 110 may also include, without limitation, multi-touch desk surfaces, cameras, radio-frequency identification (RFID) student identity cards, wireless fidelity keyed devices such as handheld or other portable devices, motion sensing interactive wands, pen input devices, physical teaching implements such as digital tangrams or Universal Serial Bus (USB) microscopes, or digital facial recognition systems. Alternatively, the present system, method, and product may be used in connection with a single data source.

Data transformer 120 receives data files 115 and transforms data files 115 into standardized data 130 which conforms to one or more standards. The one or more standards may be any conceivable rules, forms, principles, or other guidelines for the normalization of data in accordance with user preferences. For example and without limitation, the one or more standards may be comprised of desired transformations of the metadata associated with one or more data elements (such as student names or identity numbers), or with one or more rows or columns in tables created by merging data files 115. The one or more standards may include, without limitation, a particular form or forms in which standardized data 130 is to be rendered, such as formatting requirements provided by a school district or a state department of education. Without limitation, the one or more standards may include the creation of links between particular data elements, data files, data tables, or particular rows or columns within particular data tables.

The following provides an illustrative example of the transformation of data files 115 into standardized data 130 by data transformer 120, without limitation. Each data file may be comprised of one or more data elements. The data files 115 may be merged into a table. Each data element may be associated with a particular row in the table, as follows:

| | | | [Ethnicity | |
|---|---|---|---|---|
| [ID] | [Name] | [Address] | Code] | [Ethnicity] |
| 1045 | Jane Doe | 123 4^{th} Street | 1 | Asian |
| 1061 | George Smith | 17 Cherry Lane | 1 | Asian |
| 1080 | Alice Hilmy | 1015 44^{th} Ave. #3b | 5 | White |
| 1192 | Sam Park | 144 5^{th} Ave | 1 | Asian |

In this example, the above data has been imported by data transformer 120 from a CSV file 111 into a table. The above table includes the following data elements for each student: a student identity number (ID), the student's name, the student's address, the student's ethnicity code, and the student's ethnicity. Each ID is associated with the first row in the table. In this example, each row is associated with particular metadata unique to that row, such as a row uniqueness signature. The metadata associated with the [ID] row may be mapped, i.e., transformed in a manner which links the metadata associated with the [ID] row with the metadata associated with each of the following rows: [Name], [Address], and [Ethnicity Code]. In addition, the metadata associated with the row [Ethnicity Code] may be mapped to the metadata associated with the row [Ethnicity]. In this example, the one or more standards include the two mappings described in this paragraph. In this example, standardized data 130 has been transformed in a manner which allows a user accessing standardized data 130 to perform a search by student identity number. The mappings described above allow a user searching by a student identity number to obtain the student's name, address, and ethnicity. The mappings described above also permit the generation of a list of students which is guaranteed to be accurate. Any inaccurate combination of [Ethnicity] and [Ethnicity Code], for example, [Ethnicity Code]=1 and [Ethnicity]=White, may be rejected by data transformer 120 so that only accurate records are included in standardized data 130. This example is only illustrative, and other errors within data files 115 may be eliminated through similar processes.

After all desired transformations to data files 115 have been completed in accordance with the one or more standards, data transformer 120 outputs the standardized and merged data files as standardized data 130. Data transformer 120 transmits standardized data 130 to data aggregator 140. Data aggregator 140 permits users to perform searches on standardized data 130, to generate reports with standardized data 130, or to perform any other conceivable function with respect to standardized data 130 of which computer hardware or software is capable. For example, a user may access standardized data 130 at data aggregator 140 and perform analyses that were made possible because of the transformation of data files 115 into standardized data 130.

Without limitation, analysis of standardized data 130 may allow the user to generate comparison reports between any number of organizational units, after data transformer 120 maps one or more data elements within data files 115 to one or more organizational units, such as schools or school districts. A user may access standardized data 130 at data aggregator 140 to plot connections through a complex relational data model using a graph advanced data type (ADT). The graph ADT may produce SQL queries and table layouts to provide tabular data for use in one or more reporting engines. In one example, a teacher may search standardized data 130 to obtain efficacy results for a specific curriculum subject with respect to a specific subset of her students (perhaps English as a Second Language learners). This analysis could provide data which indicates supplemental materials are necessary for this specific demographic. In another example and without limitation, a school district administrator may search standardized data 130 to obtain efficacy results for the same curriculum subject, broken down by school and demographic subset of students. This analysis could reveal which schools have successful remediation strategies for a particular demographic of students.

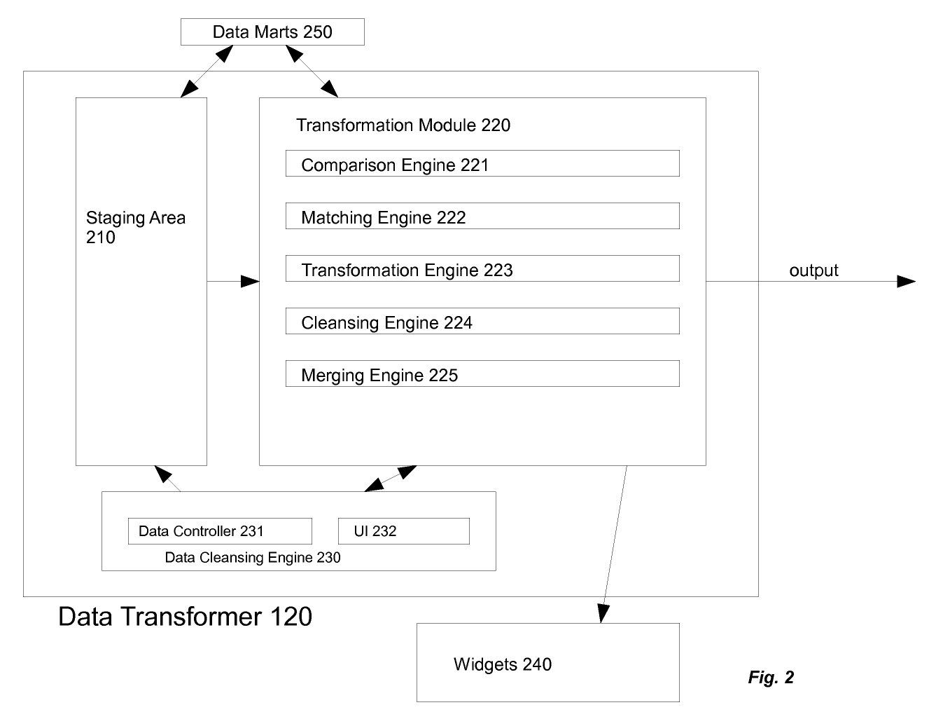

As shown in FIG. 2, there is depicted a functional block diagram illustrating in greater detail one implementation of the data transformer introduced in conjunction with FIG. 1. Data transformer 120 includes staging area 210. Staging area 210 may comprise volatile memory (for example, RAM), persistent storage, and the computer-readable media (for example, disk drive, ROM, flash memory or other solid state memory technology, etc.) associated with volatile memory and persistent storage. Computer-readable media may comprise, for example and without limitation, volatile and persistent (i.e., non-volatile) media for storage of data such as computer-readable instructions or data structures, including but not limited to DVD or other optical storage, RAM, ROM, flash memory, or any other medium which can be used to store information associated with staging area 210. Staging area 210 receives one or more data files 115 from multiple data sources 110. Staging area 210 may split data files 115 into new files or, in the alternative, may merge data files 115 into a single file. Alternatively, staging area 210 may receive data files 115 and transmit data files 115 to transformation module 220 without altering them in any way. Staging area 210 may alter data files 115 in any manner that facilitates the operations of transformation module 220.

Data transformer 120 further includes transformation module 220 and data cleansing engine 230. In this particular embodiment of the invention, staging area 210 receives one or more data files 115 from multiple data sources 110 and transmits data files 115 to transformation module 220. Transformation module 220 includes comparison engine 221, matching engine 222, transformation engine 223, cleansing engine 224, and merging engine 225.

In this particular embodiment, transformation module 220 receives one or more data files 115. Comparison engine 221 compares data files 115 to the one or more standards which are being applied to create standardized data 130, and transmits the results of that comparison to matching engine 222, transformation engine 223, cleansing engine 224, and merging engine 225. Matching engine 222 separates the matching data files from the remaining data files, so that the matching data files will remain unchanged. Transformation engine 223 transforms the remaining, non-matching data files to conform with the one or more standards. Cleansing engine 224 deletes the invalid data files, i.e., files whose data is determined to be unreliable or unusable. Alternatively, cleansing engine 224 may set aside the invalid data files for further user analysis. Merging engine 225 merges the transformed data files into standardized data 130. Transformation module 220 transmits standardized data 130 to data cleansing engine 230. Transformation module 220 may transmit standardized data 130 to data cleansing engine 230 in one batch, at the end of all processes described above. Alternatively, data cleansing engine 230 may permit a user to view and control in real time the processes occurring within transformation module 220.

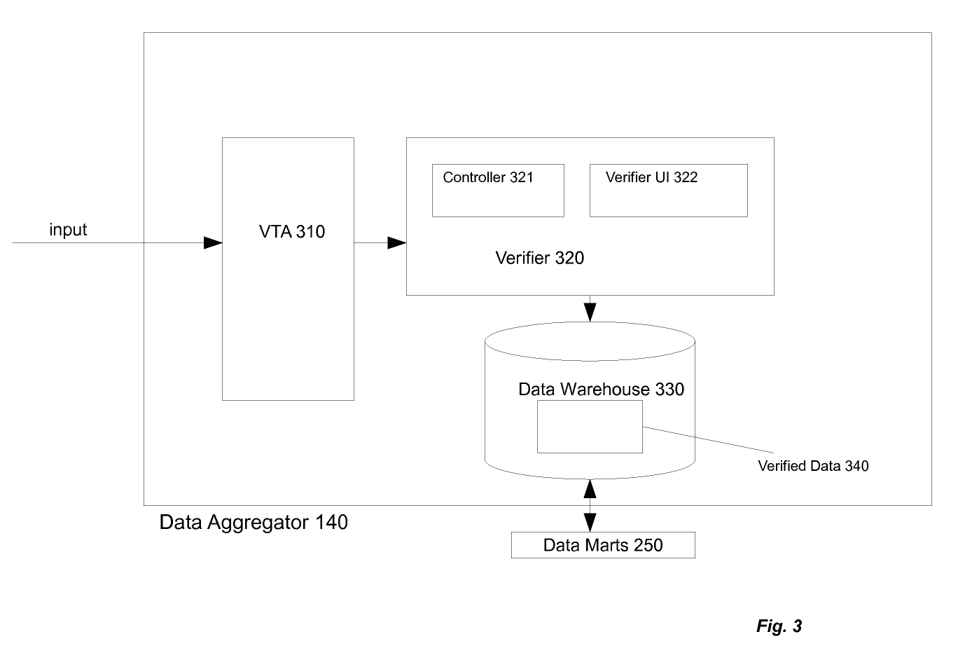

In this particular embodiment, data cleansing engine 230 includes data controller 231 and user interface (UI) 232. Data cleansing engine 230 may be resident on one or more servers on which staging area 210 and transformation module 220 are also resident. Alternatively, data cleansing engine 230 may be resident on one or more servers, desktop computers, laptop computers, or other data storage devices which are remote from staging area 210 and/or transformation module 220. For example and without limitation, data cleansing engine 230 may be resident on one or more data marts, i.e., computer servers or other storage devices each of which contain data for use by one or more entities within an organization. The one or more data marts, or any of them, may communicate with a data warehouse 330 (described below in connection with FIG. 3). The one or more data marts, or any of them, may receive verified standardized data 340 (described below in connection with FIG. 3), or a subset of verified standardized data 340, from data warehouse 330 at any given time. The one or more data marts, or any of them, may also transmit data to data warehouse 330 as described in the following paragraphs. The one or more data marts, or any of them, may comprise one or more of the multiple data sources 110. The one or more data marts, or any of them, may be synchronized with staging area 210 to send and/or receive data files 115 at any given time, or on a regularly scheduled or other periodic basis. The one or more data marts, or any of them, may be synchronized with transformation module 220 to receive standardized data 130 at any given time, or on a regularly scheduled or other periodic basis. Encrypted multi-location replication may allow consistent data redundancy and rollover. Data and system health components may keep constant vigil to ensure data accuracy, operational efficiency, and data security for both software and hardware components of the present invention. Integrated import/export data conduits may be used for the transmission, reception, and/or integration of data in connection with the present inventive system, method, and product.

In this particular embodiment, when transformation module 220 transmits standardized data 130 to data cleansing engine 230, data cleansing engine 230 renders standardized data 130 via UI 232. The user may then use data controller 231 to indicate desired changes to standardized data 130, and to instruct transformation module 220 to implement the desired changes. The instruction to implement the desired changes may be transmitted to staging area 210 for relay to transformation module 220. Alternatively, the instruction to implement the desired changes may be transmitted directly to transformation module 220. In another alternative, the user may use data controller 231 to signal to transformation module 220 that the user has approved standardized data 130 for output to data aggregator 140. The signal that the user has approved standardized data 130 may be transmitted to staging area 210 for relay to transformation module 220 or, in the alternative, may be transmitted directly to transformation module 220.

Data cleansing engine 230 may also permit the user to alter one or more selected data files chosen from among data files 115 before they are transmitted to transformation module 220. In this example, staging area 210 receives data files 115. Data cleansing engine 230 renders user interface (UI) 232, which displays data files 115 in one or more forms which are intelligible to the user of data cleansing engine 230. Data controller 231 permits the user to cause staging area 210 to make any desired changes to the selected data files before data files 115 are transmitted to transformation module 220. When the user indicates all desired changes have been made, data controller 231 instructs staging area 210 to transmit data files 115 to transformation module 220.

In another embodiment, the functions of data cleansing engine 230 may be distributed among different devices in a manner which allows a plurality of users to participate in auditing and synchronization (syncing) between multiple data sources 110 and data transformer 120. Alternatively, the functions of data cleansing engine 230 and verifier 320 (described below in connection with FIG. 3) may be performed by the same device. Automated incremental backups, intrusion attempt detection and data transfer integrity checks based on Test Procedure Specification (TPS) message logs may be used in connection with the present invention to perform long term security audits and short term probes. Field level bidirectional syncing and record collision handling can be made possible with sophisticated record activity pattern logs.

UI 232 may be rendered by a conventional web browser or by any other known method or means—for example and without limitation, Asynchronous Javascript and XML (AJAX). Styling may be accomplished via CSS style sheets or any other technique. Custom templates may allow different organizational entities to alter the graphical representations of UI 232 to suit their particular needs or desires.

In this particular embodiment, transformation module 220 is in communication with one or more widgets 240, i.e., one or more software engines which permit information to be displayed on a graphical user interface. Widgets 240 may be resident on one or more remote devices, for example and without limitation, desktop computers, laptop computers, handheld devices, other portable devices, or any other device capable of rendering a graphical user interface. Transformation module 220 may transmit selected data chosen from the standardized data to one or more widgets 240. One or more widgets 240 may allow various reports to be extracted from the standardized data 130 created by transformation module 220, in real time or, alternatively, at the end of the transformation process. One or more widgets 240 may further allow reports, charts, graphs, or other data to be printed for the user's convenience. Widgets 240 may render visual data in HTML, PDF, CSV, Excel, PNG, SPSS, and XML, or any other format.

One or more widgets 240 may provide one or more graphical dashboards allowing the display of real-time feeds of conditions within data transformer 120, as well as usage statistics and performance monitoring. Information displays provided by widgets 240 may provide a wide variety of user benefits. For example, the information displays provided by widgets 240 may allow different school administration officials to keep track of pertinent system status for optimal day to day operations.

One or more widgets 240 may generate live alerts relating to system operations, including but not limited to email, SMS, instant messaging, automated text-to-speech dialers as well as configurable output channels to deliver real-time system outage and/or error alerts to system administrators. Smartphone-based mini management dashboards may allow fine-tuned problem resolution by users who lack access to a more conventional computer. A task scheduler operating in tandem with hardware monitoring in connection with the present inventive system, method, and product may facilitate real-time data collection of operating environment conditions. The collected data may be used both for live information feeds and triggered event alerts (including email, instant message, SMS and automated dialers).

FIG. 3 depicts a functional block diagram illustrating in greater detail one implementation of the data aggregator introduced in conjunction with FIG. 1. In this particular embodiment of the invention, data aggregator 140 includes virtual table aggregator (VTA) 310, verifier 320, and data warehouse 330. In this particular embodiment, verifier 320 includes controller 321, and verifier user interface (verifier UI) 322. Verifier 320 may be resident on a server on which VTA 310 and data warehouse 330 are also resident. Alternatively, verifier 320 may be resident on a server, desktop computer, laptop computer, or other data storage device which is remote from VTA 310 and/or data warehouse 330. For example and without limitation, verifier 320 may be resident on one or more data marts.

VTA 310 may be any combination of computer hardware and/or computer software which permits standardized data 130 to be stored and organized. In this particular embodiment, VTA 310 receives standardized data as an input from data transformer 120. VTA 310 stores standardized data 130 in a virtual data structure from which one or more multidimensional relational data sets (also known as “contexts”) may be created. The one or more multidimensional relational data sets may be pivoted and/or joined as desired by the user. Further, clustered indexes, nonclustered indexes, multi-column indexes, and other data structures may be created within and among the one or more multidimensional relational data sets as desired by the user.

In this particular embodiment, when VTA 310 receives standardized data 130, verifier 320 renders standardized data 130 via verifier user interface (verifier UI) 322. (As used herein, verified standardized data 340 means standardized data 130 which has been approved by the user of verifier 320 for importation into data warehouse 330.) The user may then use controller 321 to make desired changes to standardized data 130. When all desired changes have been made, the user may further use controller 321 to import verified standardized data 340 into data warehouse 330. In the alternative, the user may approve standardized data 130 without making any changes, and may use controller 321 to import verified standardized data 340 (which in this instance would be identical to standardized data 130) into data warehouse 330.

Data warehouse 330 may be any combination of computer hardware and/or computer software which permits verified standardized data 340 to be stored and organized in a multidimensional, relational database. For example and without limitation, data warehouse 330 may store verified standardized data 340 in the form of one or more online analytical processing (OLAP) cubes or other data cubes which can be searched and analyzed across a plurality of dimensions.

As described above, data warehouse 330 may be synced with one or more data marts. Native syncing abilities may allow integration with existing authentication systems. Groups and permissions may be synced down, allowing for a centralized user management process. Customizable security architecture may allow the creation of groups and roles that fit the needs of the installed environment.

Intelligent data mirroring and off-site backup systems may be available to prevent data loss. In one embodiment, the present inventive method, system, and product may operate natively with one or more SQL servers. Custom data brokers may be implemented for other data sources including modern cloud storage technologies.

Scheduled incremental backups, full backups, remote application and cross-site encrypted data stores may be available to ensure that during critical hardware failure, minimal to no data loss occurs and downtime is negligible. Shared resource pooling during catastrophic failure may allow redundancy to scale from within the same data center to multiple geographic locations automatically, allowing proper measures to be taken in the case of natural or facility disaster.

In one embodiment, in order to integrate data from each level, data marts and warehouses may be interchangeable at each layer up to the top level, depending upon whether they are up syncing or down syncing. This may allow incoming integration servers to perform any data transformations when the data is pushed. Data may be normalized and transferred with a modified standard (such as Schools Interoperability Framework (SIF)).

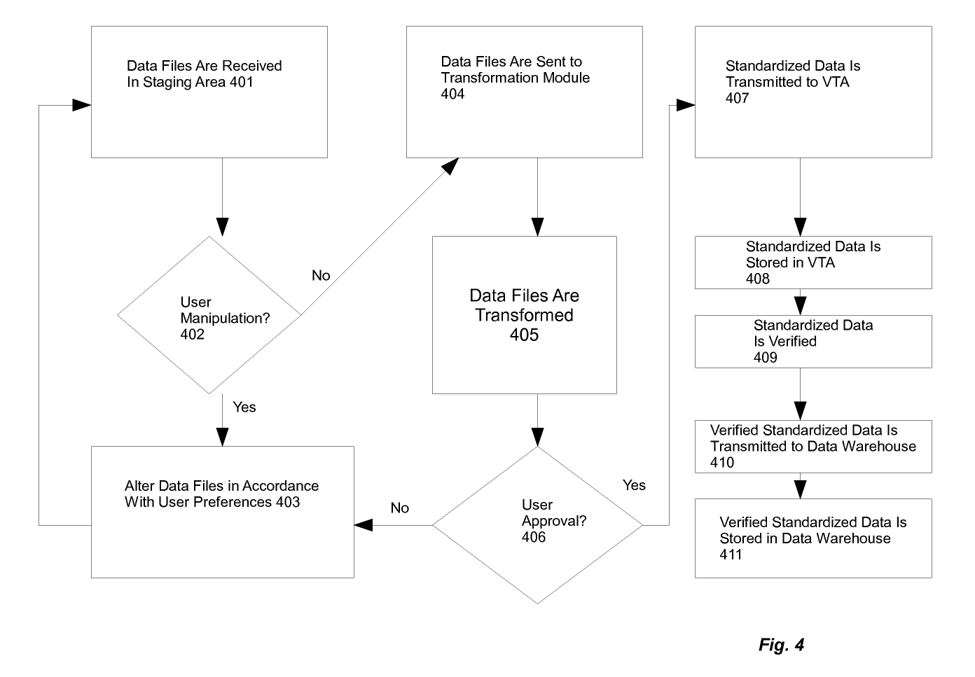

FIG. 4 is a schematic flow diagram generally illustrating one embodiment of the present method, system, and product for data integration and virtual table management. The process includes step 401, at which one or more data files 115 are received in staging area 210. At step 402, the user of data cleansing engine 230 examines data files present in staging area 210. If the user utilizes data controller 231 to make changes to data files 115, then at step 403 data files 115 are altered in accordance with user preferences. Data files 115 are then transmitted to staging area 210, and step 401 is repeated. Alternatively, at step 402, if the user wishes to leave data files 115 unaltered, the user utilizes data controller 231 to cause staging area 210 to transmit data files 115 to transformation module 220. At step 404, data files 115 are sent to transformation module 220.

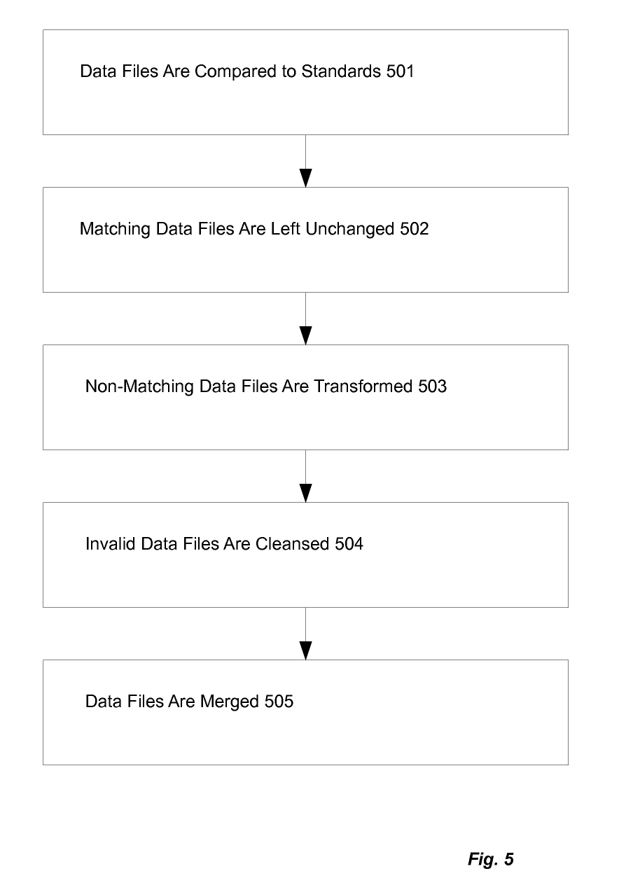

At step 405, one or more data files 115 are transformed into standardized data 130. This step is discussed in greater detail below, in conjunction with FIG. 5. At step 406, the user of data cleansing engine 230 may approve standardized data 130 for transmission to VTA 310. In that case, at step 407 standardized data 130 is transmitted to VTA 310. Alternatively, at step 406, if the user does not approve standardized data 130 for transmission to VTA 310, the user may utilize data controller 231 to make changes to data files 115. Step 403 is then repeated, and data files 115 are altered in accordance with user preferences. Data files 115 are then transmitted to staging area 210, and step 401 is repeated.

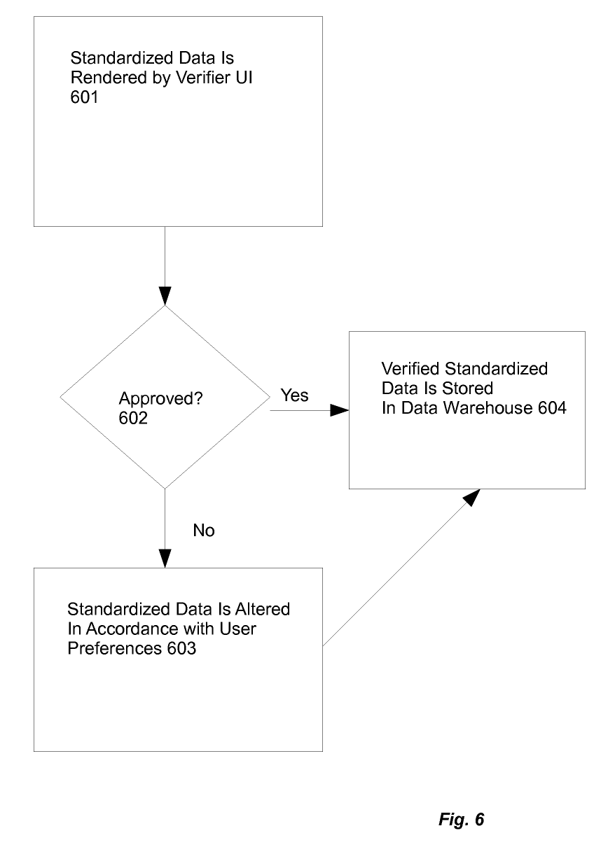

At step 408, standardized data 130 is stored in virtual table aggregator 310. At step 409, standardized data 130 is verified through utilization of verifier 320. This step is discussed in greater detail below, in conjunction with FIG. 6. At step 410, verified standardized data 340 is transmitted to data warehouse 330. At step 411, verified standardized data 340 is stored in data warehouse 330.

FIG. 5 is another schematic flow diagram illustrating in greater detail the process for transforming data files introduced at step 405 in conjunction with FIG. 4. At the preceding step 404, one or more data files 115 were sent to transformation module 220. At step 501, data files 115 are compared, by comparison engine 221, to the one or more standards which are being applied to create standardized data 130, and the results of that comparison are transmitted to matching engine 222, transformation engine 223, cleansing engine 224, and merging engine 225. At step 502, matching engine 222 separates the matching data files from the remaining data files, so that the matching data files will remain unchanged. At step 503, transformation engine 223 transforms the remaining, non-matching data files to conform with the one or more standards. At step 504, cleansing engine 224 deletes the invalid data files, i.e., files whose data is determined to be unreliable or unusable. Alternatively, cleansing engine 224 may set aside the invalid data files for further user analysis. At step 505, merging engine 225 merges the transformed data files into standardized data 130.

FIG. 6 is yet another schematic flow diagram illustrating in greater detail the process for verifying standardized data 130 introduced at step 409 in conjunction with FIG. 4. At step 601, standardized data 130 is rendered by verifier UI 322. At step 602, the user determines whether standardized data 130 is ready for importing into data warehouse 330. If the user determines standardized data 130 is ready for importing, then step 604 follows, and the verified standardized data 340 is stored in data warehouse 330. If the user determines standardized data 130 is not ready for importing, then at step 603 the user utilizes controller 321 to alter standardized data in accordance with the user's preferences. Step 604 follows.

As will be appreciated by those persons skilled in the art, the present inventive method, system, and product, inclusive of one or more embodiments of its operation through software and hardware systems and the like, affords distinct business advantages not previously available to businesses, schools, and other organizations relating to the integration and transformation of data. The present inventive method offers many advantages over previous data systems, which use ineffective legacy technologies as well as databases which are not unified and do not conform to a set of one or more standards.

In contrast to previously existing data systems, the present inventive method, product and system allows records from different organizational entities to be normalized into standard table structures for syncing across multiple locations into secure data stores. The present inventive method, system, and product may, for example, be used in connection with school districts or other educational institution(s) which use different Student Information Systems (SIS) which adhere to different sets of standards. After the data files are transformed by the data transformer and imported into the data warehouse as verified standardized data, the verified standardized data may easily be searched to identify new relationships and connections between data that were previously invisible or inaccessible. The data warehouse will enable the verified standardized data to be analyzed, or “mined”, in ways that were previously difficult or impossible.

Moreover, if a school district inputs its data files for transformation as described herein, and those data files are converted to verified standardized data stored in the data warehouse, the school district will easily be able to retain access to its historical data even if the school district switches from one SIS to another. Normalization of data, through the process of transforming data files into standardized data, verifying the standardized data, and storing the verified standardized data in a data warehouse, will facilitate compliance with various reporting requirements. Previous data systems, which applied various different and sometimes conflicting standards, made this difficult if not impossible. The present inventive method, system, and product also facilitates pushing data to, and pulling data from, existing legacy data systems, thereby easing the burden of migration to and from future data solutions.

Using education as an example but without limitation, state and federal reporting is currently modeled after a paper-based data collection system. Among other significant advantages, the present inventive method, system, and product may allow the phasing out of various currently existing reporting processes. A normalized central data warehouse would allow reports to be pulled at virtually any time. Live data feeds would allow up-to-the-minute access to educational data via a blended interface of modern dashboards and flexible reporting. When the time comes for reports or in-depth statistical reviews, the system described herein would be ready to produce the most recent data available or transactional snapshots in time based on data check-in dates. Federally mandated No Child Left Behind attendance information reports may be available any time, as may be state and custom district reports. Demographic and statistical data may be normalized and named to one or more standards that are compliant with the US Department of Education/National Center for Educational Statistics guidelines and laws for Federal and State reporting.

The data warehouse described herein may allow guardians to access student data via local dashboards, which may further allow them to see statistics on other education environments—locally or even nationally. Students may be able to access the data warehouse to view longitudinal records of their entire academic careers, in a manner which is difficult or impossible with previously existing data systems. Standardized data may be verified by guardians and students, as well as teachers and school administrators. Teachers may collaborate across the boundaries of school and district, creating a constantly improving centralized repository of curricula and teaching knowledge backed by real data analytics. Policymakers at state and national levels may leverage the data warehouse to gauge the effectiveness of policy changes, and evaluate results from similar decisions made in the past.

The data warehouse and/or one or more data marts described herein may be operated as cloud clients which can be run on local machines, thereby allowing school districts to utilize resources and cycles in-house for local data analytics without incurring the cost of purchasing high-horsepower application and analytic servers.

The present inventive system, method, and product allows student attendance to be monitored in a variety of ways previously existing systems do not allow. Multiple entry methods, reports and maintenance interfaces are available for keeping attendance. Further, with the inclusion traditional action and consequence reporting in the data files, information on referrals and source of disciplinary action may be tracked and stored in the data warehouse. This unique process and report system surrounding discipline may be customizable to the policies of one or more organizational entities, while maintaining data in a manner that allows state reporting requirements to be met. The system, method, and product described herein may allow multi-year enrollment and student migration reports to be available for large-scale district management through the use of a data warehouse and one or more data marts.

The present inventive system, method, and product may allow small districts to have consistent access to usable data systems via co-ops or collaboratives while larger districts may use their own integrated data systems to support their larger-scale processes. Each state and district may run their own data systems as they like, and may also input data files for transformation in accordance with the one or more standards to enable their data to be shared with other organizational entities.

While this invention has been described in connection with what are currently considered to be the most practical and desirable embodiments, it is to be understood that the invention is not limited to the disclosed embodiments in any way as such are merely set forth for illustrative purposes. The present inventive system, method, and product are intended to cover an array of various modifications and equivalent arrangements, all of which are contemplated for inclusion within the scope and spirit of the disclosure and appended claims.

What is claimed is:

1. A method for integrating and transforming one or more data files, comprising, in no particular order, the steps of:
receiving the one or more data files at a staging area;
transmitting the one or more data files to a transformation module;
transforming the one or more data files into standardized data which conforms to one or more standards;
transmitting the standardized data to a virtual table aggregator;
storing the standardized data in the virtual table aggregator;
verifying the standardized data conforms to the one or more standards;
transmitting the verified standardized data to a data warehouse; and
storing the verified standardized data in the data warehouse.

2. The method of claim 1, wherein the data warehouse communicates with one or more data marts.

3. The method of claim 1, wherein the transformation module communicates with one or more data marts.

4. The method of claim 1, wherein the staging area communicates with one or more data marts.

5. The method of claim 1, further comprising the step of altering the one or more data files in a manner which facilitates the operations of the transformation module.

6. The method of claim 1, further comprising the step of transmitting the standardized data to a data cleansing engine.

7. The method of claim 6, further comprising the steps of:
rendering the standardized data via a user interface; and
instructing the transformation module to implement one or more desired changes to the standardized data.

8. The method of claim 1, further comprising the step of transmitting the one or more data files to a data cleansing engine.

9. The method of claim 8, further comprising the steps of:
rendering the one or more data files via a user interface;
causing the staging area to make one or more desired changes to selected data files chosen from among the one or more data files; and
instructing the staging area to transmit the one or more data files to the transformation module.

10. The method of claim 1, further comprising the step of transmitting selected data chosen from the standardized data to one or more widgets.

11. The method of claim 10, further comprising one or more of the following steps:
allowing one or more reports to be extracted from the selected data;
allowing one or more reports, charts, graphs, or other visual data to be printed;
providing one or more graphical dashboards or other information displays;
generating one or more live alerts relating to system operations.

12. The method of claim 1, wherein the step of verifying the standardized data further includes making one or more changes to the standardized data.

13. The method of claim 1, wherein the one or more data files are received from multiple data sources.

14. The method of claim 13, wherein at least one of the multiple data sources is associated with one or more entities from a group including: one or more business divisions, one or more business departments, one or more business headquarters, one or more students, one or more teachers, one or more classrooms, one or more schools, one or more school districts, one or more boards of education, one or more local departments of education, one or more state departments of education, and the United States Department of Education.

15. The method of claim 13, wherein at least one of the multiple data sources is selected from a group including: one or more computer servers, one or more laptop computers, one or more desktop computers, one or more handheld computers, one or more portable computers, one or more multi-touch desk surfaces, one or more cameras, one or more radio-frequency identification (RFID) student identity cards, one or more wireless fidelity keyed devices such as handheld or other portable devices, one or more motion sensing interactive wands, one or more pen input devices, one or more physical teaching implements, digital tangrams, one or more Universal Serial Bus (USB) microscopes, and one or more digital facial recognition systems.

16. A system for integrating and transforming one or more data files, comprising:
means for receiving the one or more data files at a staging area;
means for transmitting the one or more data files to a transformation module;
means for transforming the one or more data files into standardized data which conforms to one or more standards;
means for transmitting the standardized data to a virtual table aggregator;
means for storing the standardized data in the virtual table aggregator;
means for verifying the standardized data conforms to the one or more standards;
means for transmitting the verified standardized data to a data warehouse; and
means for storing the verified standardized data in the data warehouse.

17. A system apparatus for integrating one or more data files and transforming the one or more data files for storage in a data warehouse, the system apparatus comprising:
a staging area which receives the one or more data files;
a transformation module which transforms the one or more data files into standardized data, the standardized data conforming to one or more standards;
a data cleansing engine which enables implementation of desired changes in the standardized data;
a virtual table aggregator configured to receive and store the standardized data;
a verifier which enables approval of the standardized data or alteration of the standardized data in accordance with user preferences; and
a data warehouse configured to receive and store verified standardized data.
